(19) United States
(12) Patent Application Publication
(10) Pub. No.: US 2012/0162442 A1
(43) Pub. Date: Jun. 28, 2012

(54) AUTOMATIC VIDEO DELAY CORRECTION METHOD

(75) Inventors: Chih-Chun Ho, New Taipei City (TW); Chih-Yuan Ho, New Taipei City (TW)

(73) Assignee: ABA Electronics Technology Co., Ltd., New Taipei City (TW)

(21) Appl. No.: 13/101,339

(22) Filed: May 5, 2011

(30) Foreign Application Priority Data
Dec. 28, 2010 (TW) 099146275

(51) Int. Cl. H04N 17/02

(52) U.S. Cl. 348/192; 348/E17.004

(57) ABSTRACT

An automatic video delay correction method in which an automatic delay equalizer is used. The method includes steps of: using a processor to read a video signal and analyze and judge whether the back porch of the three primary color signal in a received video signal is the same; if not, using a delay regulator to automatically adjust the delay time of any two leading or trailing primary color signal to generate an adjusted back porch of two primary color signal; using the processor to compare the adjusted back porch of the two primary color signal with the back porch of a maximum delay time to judge whether the adjusted back porch is the same as the back porch of the maximum delay time; and if so, using the processor to generate an adjusted video signal and transmit the adjusted video signal to a remote-end receiving device.

This application claims the priority benefit of Taiwan patent application number 099146275 filed on Dec. 28, 2010.

### FIELD OF THE INVENTION

The present invention relates to an automatic video delay correction method. By means of this method, the video signals received by a remote-end receiving device can be automatically adjusted to synchronously and conveniently display the three primary color signal in the video signal.

### BACKGROUND OF THE INVENTION

In a public site such as an airport, a metro train and a theater, a remote-end receiving device such as an electronic signboard, a television, etc. is connected to an electronic device at the other end, (such as a DVD player, a computer and a notebook), via a signal transmission cable. The video signals output from the electronic device are transmitted to the remote-end receiving device via the signal transmission cable for the remote-end receiving device to play the received video signals.

However, a common signal transmission cable is subject to affection of environmental factors such as humidity, weather and aging of the cable material. As a result, the video signals are likely to be distorted. Moreover, the length of the signal transmission cable is limited to several meters. In the case that the length of the signal transmission cable exceeds the range, the video signals will attenuate to lead to delay between the three primary color (R.G.B.) signals in the video signals.

This is illustrated with an example as follows: In the case that the distance between the remote-end receiving device and the electronic device exceeds the length range of the signal transmission cable, the three primary color (R.G.B.) signals in the video signals transmitted from the electronic device will be delayed and cannot synchronously reach the remote-end receiving device. This will result in vagueness, smear or color offset of the picture displayed on the remote-end receiving device.

To solve the above problem, a manual video delay correction method has been developed as shown in FIG. 1. A manually operable delay equalizer 10 is used in the manual video delay correction method. The manually operable delay equalizer 10 has a red color adjustment button 101, a green color adjustment button 102 and a blue color adjustment button 103 arranged on one side of the manually operable delay equalizer 10 for a user to rotate.

The other side of the manually operable delay equalizer 10 is connected to a remote-end receiving device 12 such as an electronic signboard or a television. The remote-end receiving device 12 is connected to the manually operable delay equalizer 10 via a VGA signal cable A2 for transmitting video signals.

One side of a transmitter 14 is connected to the other side of the manually operable delay equalizer 10 via a signal transmission cable A1 such as a CAT5 cable for transmitting video signals. The other side of the transmitter 14 is connected to an electronic device 16 via a VGA signal cable A3. The video signals generated by the electronic device can be transmitted to the transmitter 14 via the VGA signal cable A3.

Further referring to FIG. 1, the method includes steps of: using the electronic device 16 to transmit the video signals to the transmitter 14; using the transmitter 14 to transmit the video signals to the manually operable delay equalizer 10 via the signal transmission cable A1, the manually operable delay equalizer 10 serving to transmit the received video signals to the remote-end receiving device 12 to display; and inserting a tool 171 such as a screwdriver into the red color adjustment button 101, green color adjustment button 102 and blue color adjustment button 103 of the manually operable delay equalizer 10 to rotate the adjustment buttons for adjusting the video signals.

According to the above method, a user 17 needs to continuously observe the remote-end receiving device 12 at the same time to see whether the colors (three primary colors R.G.B.) of the video signals displayed on the remote-end receiving device 12 match the original colors of the video signals transmitted from the electronic device 16. If the colors of the video signals displayed on the remote-end receiving device 12 match the original colors of the transmitted video signals, the user 17 stops rotating the adjustment buttons. On the contrary, if the colors of the video signals displayed on the remote-end receiving device 12 fail to match the original colors of the transmitted video signals, the user 17 needs to continuously observe the remote-end receiving device 12 and repeatedly rotate the respective adjustment buttons to adjust the colors until the colors of the video signals displayed on the remote-end receiving device 12 match the original colors of the video signals transmitted from the electronic device 16.

By means of the conventional manual video delay correction method, the distortion of the video signals displayed on the remote-end receiving device 12 can be improved. However, the effect is limited. This is because when adjusting the adjustment buttons of the manually operable delay equalizer 10, the displayed video signals are distinguished with human eyes. It is hard for a user to precisely adjust the three primary color (R.G.B.) signals of the video signals to synchronously truly display the video signals. Therefore, by means of the conventional manual video delay correction method, the colors of the video signals can be only adjusted to be approximate to the original colors of the transmitted video signals. It is impossible to adjust the colors of the video signals to be totally identical to the original colors of the transmitted video signals. Moreover, the adjustment process is quite troublesome and complicated.

Furthermore, the signal transmission cable A1 is subject to affection of various factors such as weather, humidity and aging of the cable material. Therefore, a user needs to frequently go for checking the remote-end receiving device 12 and adjust/correct the picture displayed thereon. This leads to increase of labor cost and inconvenience in use of the device.

According to the aforesaid, the conventional technique has the following shortcomings:
1. It is hard to precisely adjust the three primary color signals of the video signals to synchronously truly display the video signals.
2. The adjustment process is quite troublesome and complicated.
3. The signal transmission cable is subject to affection of various environmental factors so that a user needs to frequently adjust and correct the picture displayed on the remote-end receiving device. This leads to increase of labor cost and inconvenience in use of the device.

### SUMMARY OF THE INVENTION

A primary object of the present invention is to provide an automatic video delay correction method. By means of this method, the video signals received by a remote-end receiving device can be automatically adjusted to synchronously display the three primary color signal in the video signal and overcome the problem of affection of the environmental factors (such as weather, humidity and aging of the cable material).

A further object of the present invention is to provide the above automatic video delay correction method. By means of this method, it is no more necessary for an operator to frequently check and adjust the picture displayed on the remote-end receiving device. Accordingly, the adjustment process can be more conveniently performed.

A still further object of the present invention is to provide the above automatic video delay correction method. By means of this method, the adjustment process is simplified so that the adjustment time is shortened.

To achieve the above and other objects, the automatic video delay correction method of the present invention is applied to an automatic delay equalizer. The method includes steps of: using a processor to read a video signal and analyze and judge whether the back porch of the three primary color signal in the video signal is the same; if not, using a delay regulator to automatically adjust the delay time of any two leading or trailing primary color signal to generate an adjusted back porch of two primary color signal; using the processor to read the adjusted back porch of the two primary color signal and compare the adjusted back porch with the back porch of a maximum delay time to judge whether the adjusted back porch of the two primary color signal is the same as the back porch of the maximum delay time; and if so, using the processor to generate an adjusted video signal and transmit the adjusted video signal to a remote-end receiving device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing a conventional manual video delay correction method;

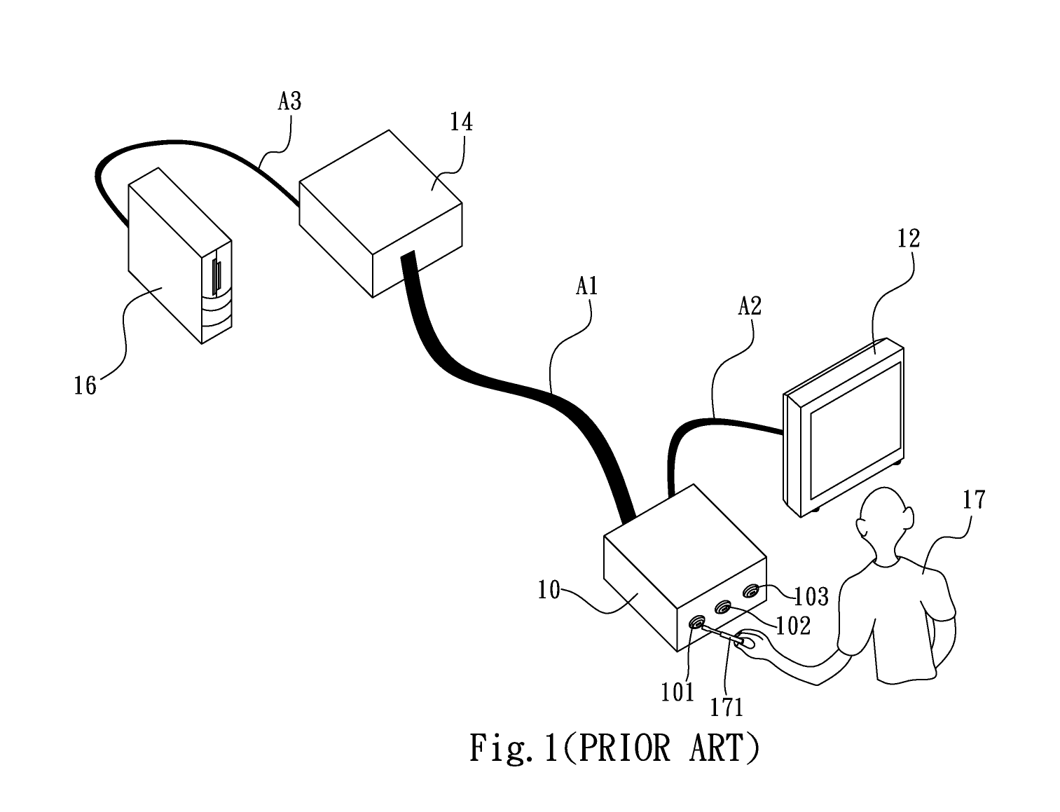

FIG. 2 is a perspective view showing a preferred embodiment of the automatic video delay correction method of the present invention;

FIG. 3 is a block diagram of the preferred embodiment of the automatic video delay correction method of the present invention; and

FIG. 4 is a flow chart of the preferred embodiment of the automatic video delay correction method of the present invention.

### DETAILED DESCRIPTION OF THE PREFERRED EMBODIMENTS

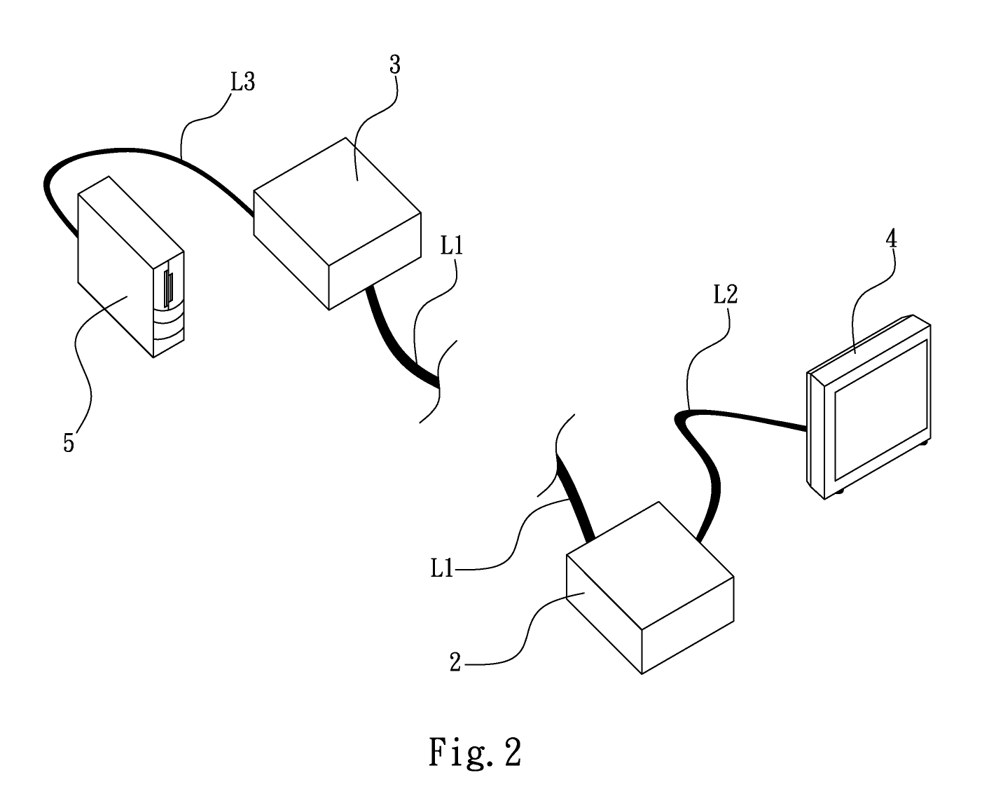

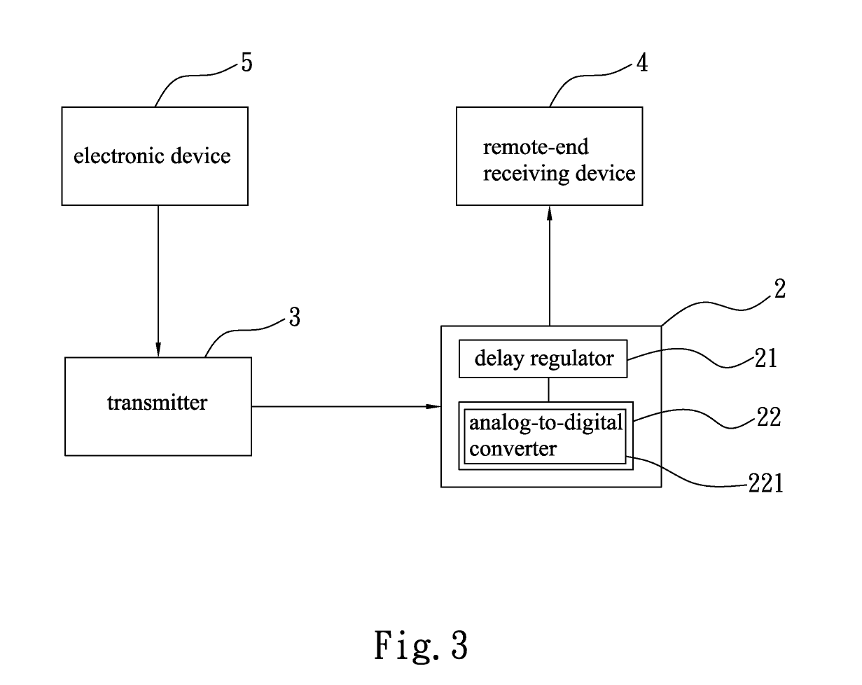

Please refer to FIGS. 2 and 3, which show a preferred embodiment of the automatic video delay correction method of the present invention. An automatic delay equalizer 2 is used in the method. The automatic delay equalizer 2 is connected to a transmitter 3 and co-used therewith. The transmitter 3 is connected with the automatic delay equalizer 2 via a first transmission cable L1 for transmitting signals (such as video signals). The first transmission cable L1 can be a CAT5 cable, a CAT5e cable or a CAT6 cable. In this embodiment, the first transmission cable L1 is a CAT5e cable for illustration purposes only.

One side of the transmitter 3 is connected to an electronic device 5, for example, a video player (such as a DVD player or a VCD player), a computer or a notebook via a third transmission cable L3. The other side of the transmitter 3 is connected with the first transmission cable L1. The transmitter 3 serves to receive a video signal transmitted from the electronic device 5 and transmits the video signal to the automatic delay equalizer 2 via the first transmission cable L1. After receiving the video signal, the automatic delay equalizer 2 will automatically adjust the video signal. The video signal contains the three primary color (R.G.B.) signals, a horizontal synchronizing (H-sync) signal and a vertical synchronizing (V-sync) signal. The horizontal synchronizing (H-sync) signal and the vertical synchronizing (V-sync) signal serve to synchronously trigger the three primary color (R.G.B.) signals.

The automatic delay equalizer 2 includes a delay regulator 21 and a processor 22 connected with the delay regulator 21. The delay regulator 21 serves to adjust and synchronize the three primary color (R.G.B.) signals in the video signals. The processor 22 serves to read and analyze the received video signals and judge whether it is necessary to adjust the three primary color (R.G.B.) signals in the video signals.

Further referring to FIG. 3, the processor 22 includes an analog-to-digital converter 21 (hereinafter abbreviated as ADC). The ADC 221 serves to convert the video signals from analog form into digital form or from digital form into analog form.

In addition, the automatic delay equalizer 2 is connected to a remote-end receiving device 4 via a second transmission cable L2 for transmitting the video signals. The remote-end receiving device 4 can be a display, a projector or a television. Preferably, the remote-end receiving device 4 is, but not limited to, an LCD display. In practice, the remote-end receiving device 4 can be any device capable of displaying the video signals.

The processor 22 serves to analyze and process the received video signals and judge whether it is necessary to adjust the three primary color (R.G.B.) signals in the video signals. If not, the processor 22 will directly transmit the video signals to the remote-end receiving device 4. Accordingly, the three primary color (R.G.B.) signals in the video signals can be automatically adjusted and synchronously displayed on the remote-end receiving device 4. Therefore, the adjustment time can be saved and the device can be more conveniently used.

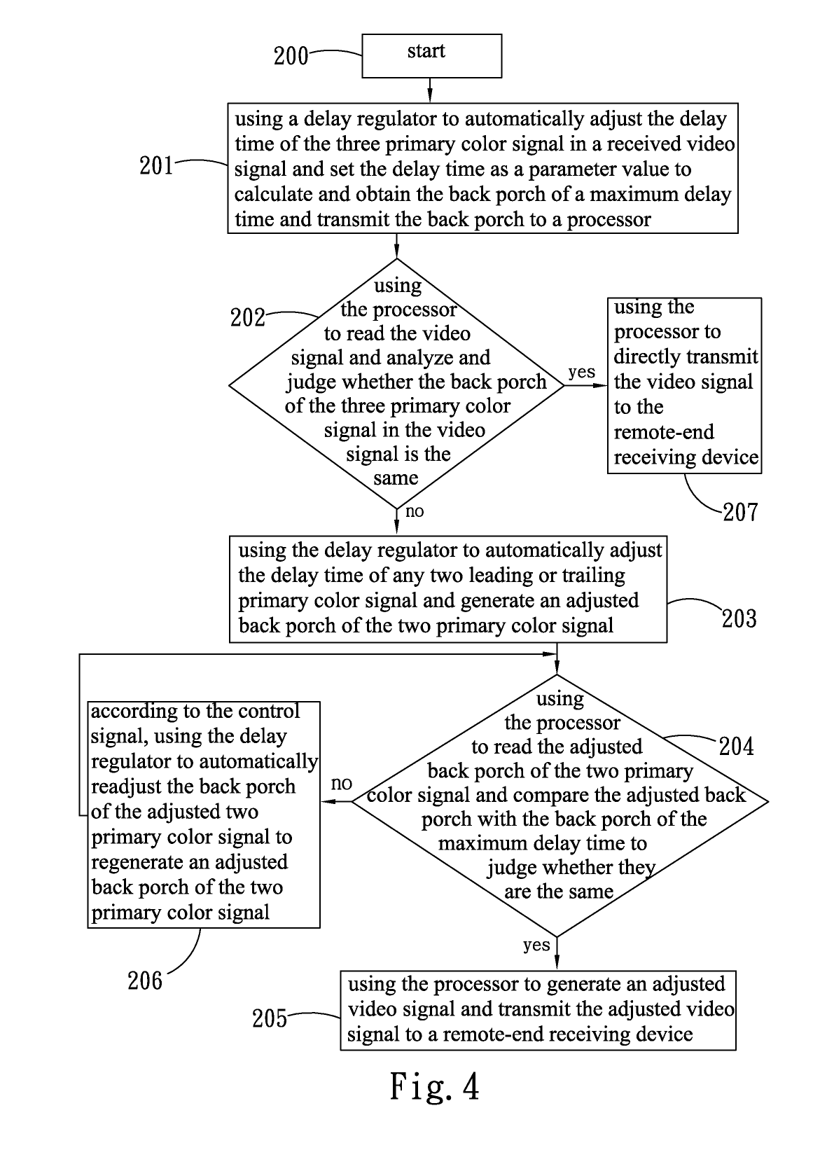

Please refer to FIG. 4, which is a flow chart of the preferred embodiment of the present invention. The automatic video delay correction method of the present invention includes:

step 200 of start;
step 201 of using a delay regulator to automatically adjust the delay time of the three primary color (R.G.B.) signal in a received video signal and set the delay time as a parameter value to calculate and obtain the back porch of a maximum delay time and transmit the back porch to a processor, the electronic device 5 serving to transmit video signal to the transmitter 3, the transmitter 3 serving to transmit the video signal to the delay regulator 21 of the automatic delay equalizer 2 via the first transmission cable L1, the delay regulator 21 automatically adjusting the delay time of the three primary color (R.G.B.) signal in the received video signal and setting the delay time as a parameter value, the parameter value being a standard value of the delay time of the three primary color (R.G.B.) signal, for example, 0, according to the set delay time of the three primary color (R.G.B.) signal, the delay regulator 21 then calculating and processing to generate the back porch of a maximum delay time and transmit the back porch to the processor 22;
step 202 of using the processor to read the video signal at the same time and analyze and judge whether the back porch of the three primary color (R.G.B.) signal in the video signal is the same, if so, the procedure going to step 207, if not, the procedure going to step 203, the processor 22 serving to read and analyze the video signal transmitted from the transmitter 3 at the same time and judge whether the back porch of the three primary color (R.G.B.) signal in the video signal is the same, if not, the procedure going to step 203, if so, the procedure going to step 207;
step 203 of using the delay regulator to automatically adjust the delay time of any two leading or trailing primary color signal in case the back porch of the three primary color (R.G.B.) signal is different, the delay regulator then generating an adjusted back porch of two primary color signal, when the processor 22 judges that the back porch of the three primary color (R.G.B.) signal is different, the processor 22 generating a control signal and transmitting the control signal to the delay regulator 21, according to the control signal, the delay regulator 21 finding that two primary color signal leads or trails the other primary color signal and then automatically adjusting the delay time of the two leading or trailing primary color signal to generate an adjusted back porch of two primary color signal and transmit the back porch to the processor 22;
step 204 of using the processor to read the adjusted back porch of the two primary color signal and compare the adjusted back porch with the back porch of the maximum delay time to judge whether the adjusted back porch of the two primary color signal is the same as the back porch of the maximum delay time, if so, the procedure going to step 205, if not, the procedure going to step 206, the processor 22 serving to read the adjusted back porch of the two primary color signal transmitted from the delay regulator 21 and compare the adjusted back porch with the back porch of the maximum delay time to judge whether the adjusted back porch of the two primary color signal is the same as the back porch of the maximum delay time, if so, the procedure going to step 205, if not, the procedure going to step 206;
step 205 of using the processor to generate an adjusted video signal and transmit the adjusted video signal to a remote-end receiving device to display in case the adjusted back porch of the two primary color signal is the same as the back porch of the maximum delay time, when the processor 22 judges that the adjusted back porch of the two primary color signal is the same as the back porch of the maximum delay time, the processor 22 finding that the adjusted back porch of the two primary color signal is the same as the back porch of the other primary color signal, in this case, according to the adjusted two primary color signal and the other primary color signal, the processor 22 operating to generate an adjusted video signal and transmit the adjusted video signal to the remote-end receiving device 4 to display, whereby the three primary color (R.G.B.) signal of the adjusted video signal can synchronously reach the remote-end receiving device 4 to display without smear, vagueness or color offset of the color of the displayed picture;
step 206 of using the processor to further generate a control signal and transmit the control signal to the delay regulator in case the adjusted back porch of the two primary color signal is different from the back porch of the maximum delay time, according to the control signal, the delay regulator readjusting the adjusted back porch of the two primary color signal to regenerate an adjusted back porch of the two primary color signal and transmit the adjusted back porch to the processor and the procedure going back to step 204, when the processor 22 judges that the adjusted back porch of the two primary color signal is different from the back porch of the maximum delay time, according to the control signal transmitted from the processor 22, the delay regulator 21 finding that the adjusted two primary color signal still leads or trails the other primary color signal and then automatically readjusting the delay time of the adjusted two primary color signal to regenerate an adjusted back porch of the two primary color signal and the procedure going back to step 204, the processor 22 repeatedly reading and analyzing the adjusted back porch of the two primary color signal until the processor 22 finds that the adjusted back porch of the two primary color signal is the same as the back porch of the maximum delay time, (that is, until the back porch of the three primary color signal is the same); and
step 207 of using the processor to directly transmit the video signal to the remote-end receiving device to display in case the back porch of the three primary color signal is the same, when the processor 22 finds that the back porch of the three primary color signal is the same, the processor 22 directly transmits the received video signal to the remote-end receiving device 4 for the remote-end receiving device 4 to display.

According to the aforesaid, by means of the present invention, the three primary color signal of the video signal can be automatically and more conveniently adjusted and synchronously displayed. Therefore, the adjustment time is shortened. In addition, the first transmission cable L1 is free from the affection of environmental factors (such as weather, humidity and aging of the cable material). Also, the problem caused by the limitation of the length of the cable is overcome. In conclusion, in comparison with the prior art, the present invention has the following advantages:
1. The three primary color signal can be automatically adjusted and synchronously displayed.
2. The adjustment process is simplified so that the adjustment time is shortened.
3. It is no more necessary for an operator to frequently check and adjust the picture displayed on the remote-end receiving device. Therefore, the adjustment process can be more conveniently performed to overcome the problem of affection of the environmental factors (such as weather, humidity and aging of the cable material).

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An automatic video delay correction method in which an automatic delay equalizer is used, the method comprising steps of:
using a processor to read a video signal and analyze and judge whether the back porch of the three primary color signal in the video signal is the same;
if not, using a delay regulator to automatically adjust the delay time of any two leading or trailing primary color signal to generate an adjusted back porch of two primary color signal;
using the processor to read the adjusted back porch of the two primary color signal and compare the adjusted back porch with the back porch of a maximum delay time to judge whether the adjusted back porch of the two primary color signal is the same as the back porch of the maximum delay time; and
if so, using the processor to generate an adjusted video signal and transmit the adjusted video signal to a remote-end receiving device.

2. The automatic video delay correction method as claimed in claim 1, wherein if the back porch of the three primary color signal is the same, the

3. The automatic video delay correction method as claimed in claim 1, wherein in the step of using the processor to read the video signal and analyze and judge whether the back porch of the three primary color signal in the video signal is the same, the delay regulator automatically adjusts the delay time of the three primary color signal in the received video signal and sets the delay time as a parameter value, the delay regulator then calculating to obtain the back porch of the maximum delay time and transmit the back porch to the processor.

4. The automatic video delay correction method as claimed in claim 1, wherein if the adjusted back porch of the two primary color signal is different from the back porch of the maximum delay time, the processor generates a control signal and transmits the control signal to the delay regulator, according to the control signal, the delay regulator automatically readjusting the adjusted back porch of the two primary color signal to regenerate an adjusted back porch of the two primary color signal and transmit the adjusted back porch to the processor.

5. The automatic video delay correction method as claimed in claim 1, wherein the automatic delay equalizer is connected to a transmitter and the

6. The automatic video delay correction method as claimed in claim 5, wherein the transmitter is connected to the automatic delay equalizer via a first transmission cable, the first transmission cable being selected from a group consisting of a CAT5 cable, a CAT5e cable and a CAT6 cable.

7. The automatic video delay correction method as claimed in claim 1, wherein the remote-end receiving device is selected from a group consisting of a display, a projector and a television.

8. The automatic video delay correction method as claimed in claim 1, wherein the remote-end receiving device is connected to the automatic delay equalizer via a second transmission cable, which is a VGA transmission cable.

9. The automatic video delay correction method as claimed in claim 1, wherein the automatic delay equalizer includes the processor and the delay regulator is electrically connected with the processor, the processor including an analog-to-digital converter for converting the video signal from analog form into digital form.
